(19) United States
(12) Patent Application Publication
(10) Pub. No.: US 2026/0257283 A1
(43) Pub. Date: Sep. 3, 2026

(54) WORK MACHINE

(71) Applicant: Koki Holdings Co., Ltd., Tokyo (JP)

(72) Inventor: Reo FUJIKAWA, Ibaraki (JP)

(73) Assignee: Koki Holdings Co., Ltd., Tokyo (JP)

(21) Appl. No.: 18/995,859

(22) PCT Filed: May 26, 2023
(86) PCT No.: PCT/JP2023/019618

§ 371 Date: Jan. 17, 2025

(30) Foreign Application Priority Data
Jul. 29, 2022 (JP) 2022-121301

(51) Int. Cl. B23B 45/00; B23B 45/02

(52) U.S. Cl. CPC B23B 45/008; B23B 45/02; B23B 2260/062; B23B 2260/128

(57) ABSTRACT

A work machine is provided with a Microcomputer that controls the driving of a motor. If centrifugal direction acceleration applied to an acceleration sensor exceeds a centrifugal direction acceleration threshold value, the Microcomputer reduces the rotation speed of the motor or stops the motor. The Microcomputer requires the meeting of a condition in which a load current of the motor exceeds a current threshold value (not in a no-load state) to activate a swing control function.

### TECHNICAL FIELD

The present invention relates to a work machine such as a hammer drill.

### RELATED ART

The following Patent Document 1 discloses a work machine having a function of stopping a motor when a rotating tip tool gets caught on a counter material and the work machine body is swinging. The work machine is equipped with an acceleration sensor that detects swinging of the work machine body, and stops driving the motor when an acceleration in the left-right direction detected by the acceleration sensor exceeds a threshold value.

### Prior-Art Document

### Patent Document

Patent Document 1: Japanese Patent Laid-open No. 2019-150897

### SUMMARY OF INVENTION

### Problems to be Solved by the Invention

The acceleration in the left-right direction is greatest at the moment when the work machine body begins to swing, and tends to decrease over time. For this reason, when detecting the swinging of the work machine body based on the acceleration in the left-right direction, after a short time has passed since the work machine body began to swing, it is difficult to judge whether the work machine body is not swinging or whether it is swinging but the swinging speed has become constant. Furthermore, if the rise in the swing speed is slow, it is difficult to judge whether or not the work machine body is swinging. It is possible to calculate the swinging speed to detect the swinging, but this requires integral calculation of the acceleration in the left-right direction, which is likely to result in large errors.

An object of the present invention is to provide a work machine capable of appropriately detecting a state in which the work machine body is swinging.

Means for solving the Problems One aspect of the present invention is a work machine. The work machine includes a motor; a tip tool that rotates around a rotation shaft by receiving a driving force from the motor and; a housing that supports the motor and the tip tool; a control unit that controls driving of the motor; and a detection unit supported by the housing and capable of detecting an acceleration occurring in itself. The control unit controls the driving of the motor based on a radial acceleration occurring in a radial direction around the rotation shaft with respect to the detection unit.

The present invention may be expressed as an “electric work machine”, an “electric tool”, an “electrical device”, etc., and such expressions are also valid as aspects of the present invention.

### Effects of Invention

According to the present invention, it is possible to provide a work machine capable of appropriately detecting a state in which the work machine body is swinging.

### BRIEF DESCRIPTION OF DRAWINGS

FIG. 1 is a right side cross-sectional diagram of a work machine 1 according to an embodiment of the present invention.

FIG. 2 is a circuit block diagram of the work machine 1.

(A) of FIG. 3 is a schematic diagram showing an example of a state of the work machine 1 during work. (B) is a schematic diagram of the work machine 1 in the state shown in (A) of FIG. 3 as viewed from the concrete side.

FIG. 4 is a time chart of the load current of a motor 6, the angle of the work machine body, the acceleration detection value in the X-axis direction by an acceleration sensor 24, and the acceleration detection value by the acceleration sensor 24 in the Z-axis direction when the work machine 1 is in high-speed mode and during normal cutting, i.e., when a tip tool 19 is not locked.

FIG. 5 is a time chart of the load current of the motor 6, the angle of the work machine body, the acceleration detection value by the acceleration sensor 24 in the X-axis direction, and the acceleration detection value by the acceleration sensor 24 in the Z-axis direction when the work machine 1 is in high-speed mode, the tip tool 19 is locked midway, and the swing control function is not activated.

FIG. 6 is a time chart of the load current of the motor 6, the angle of the work machine body, the acceleration detection value by the acceleration sensor 24 in the X-axis direction, and the acceleration detection value by the acceleration sensor 24 in the Z-axis direction when the work machine 1 is in low-speed mode and during normal cutting, i.e., when the tip tool 19 is not locked.

FIG. 7 is a time chart of the load current of the motor 6, the angle of the work machine body, the acceleration detection value by the acceleration sensor 24 in the X-axis direction, and the acceleration detection value by the acceleration sensor 24 in the Z-axis direction when the work machine 1 is in low-speed mode, the tip tool 19 is locked midway, and the swing control function is not activated.

FIG. 8 is a control flowchart of the work machine 1.

### DESCRIPTION OF THE EMBODIMENTS

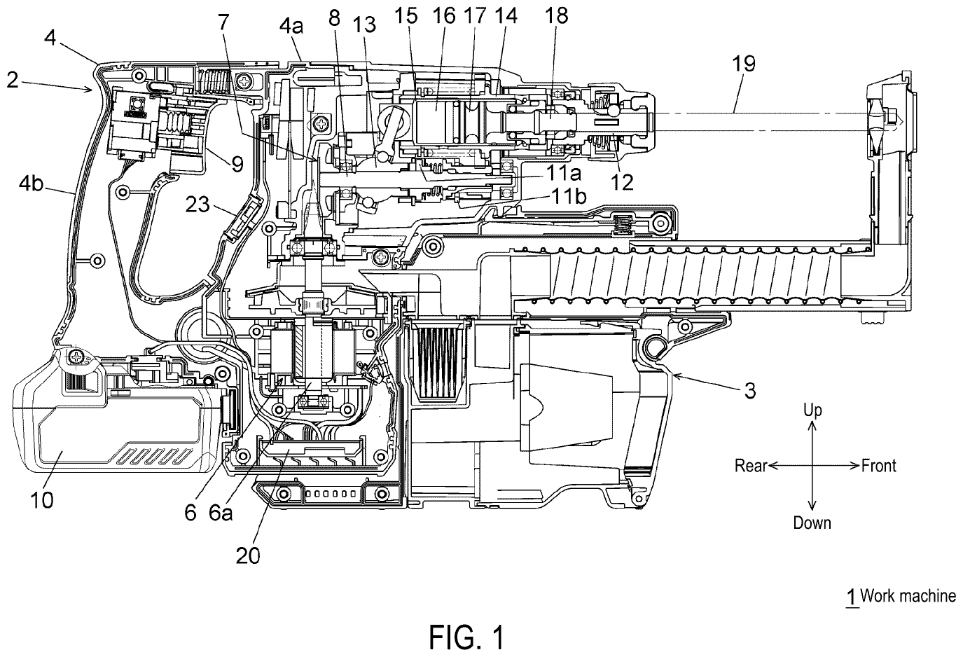

FIG. 1 is a right side cross-sectional diagram of a work machine 1 according to an embodiment of the present invention. FIG. 1 defines front-rear and up-down directions of the work machine 1 which are perpendicular to each other. Moreover, the direction perpendicular to the front-rear and up-down directions is defined as left-right direction. The front-rear direction is a direction parallel to the axial direction of the tip tool 19. The up-down direction is a direction parallel to the axial direction of an output shaft 6a of a motor 6. The left-right direction is defined based on a worker looking forward.

The work machine 1 is a drilling tool, specifically a hammer drill. The work machine 1 may perform chipping operation, drilling operation, and crushing operation on a counter material (cut material) such as concrete or stone by applying a rotational force and/or a striking force to the tip tool 19. The work machine 1 includes a body 2 and a dust collection unit 3. The body 2 includes a body housing 4. The dust collection unit 3 is detachably attached to the body housing 4.

The body housing 4 includes a body part 4a that houses and holds the motor 6, a deceleration mechanism 7, an intermediate shaft 8, a tool holding part 12, a reciprocating bearing 13, a cylinder 14, a main board 20, and the like, and a handle part 4b connected to the body part 4a in a relatively movable manner via an anti-vibration mechanism. A battery pack 10 serving as a power source is detachably connected to the rear lower part of the handle part 4b. A trigger switch 9 is provided on the handle part 4b for the worker to instruct the motor 6 to start or stop. Moreover, the body part 4a is also provided with an operation panel 23 that enables the worker to switch the rotation mode of the motor 6 between a high-speed mode and a low-speed mode. The configuration of the rotational impact mechanism (power transmission mechanism) that rotates and/or strikes the tip tool 19 by the rotation of the motor 6 is well known, so only a brief description will be given below.

The motor 6 is a brushless electric motor. The rotation of the output shaft 6a of the motor 6 is decelerated by the deceleration mechanism 7 located above the motor 6, and is changed in rotation direction by 90 degrees before being transmitted to the intermediate shaft 8. The axial direction of the intermediate shaft 8 is parallel to the front-rear direction. A first clutch mechanism 11a switches between transmitting and not transmitting the rotation of the intermediate shaft 8 to the reciprocating bearing 13. A second clutch mechanism 11b switches between transmitting and not transmitting the rotation of the intermediate shaft 8 to the cylinder 14. The transmission and interruption of rotation by the first clutch mechanism 11a and the second clutch mechanism 11b may be switched by the worker using a change lever (not shown).

The work machine 1 has three action modes: an impact mode, a rotational impact mode, and a rotation mode. The action mode is determined by the operation of the change lever. In the impact mode, the rotation transmission by the first clutch mechanism 11a is effective, and the rotation transmission by the second clutch mechanism 11b is ineffective. In the rotational impact mode, the rotation transmission by both the first clutch mechanism 11a and the second clutch mechanism 11b is effective. In the rotation mode, the rotation transmission by the first clutch mechanism 11a is ineffective, and the rotation transmission by the second clutch mechanism 11b is effective.

A piston 15 is provided within the cylinder 14. In the impact mode or rotational impact mode, the reciprocating bearing 13 converts the rotation of the intermediate shaft 8 into reciprocating motion in the front-rear direction and transmits it to the piston 15. An air chamber 16 and a striker (impacting part) 17 are provided in the piston 15 in this order from the rear. A second hammer (intermediate part) 18 is provided in front of the striker 17.

The forward movement of the piston 15 compresses the air in the air chamber 16, and the pressure (positive pressure) of the compressed air moves the striker 17 forward. The striker 17 moving forward strikes the second hammer 18, and the second hammer 18 moving forward by the striking force strikes the tip tool 19.

The rearward movement of the piston 15 causes the air in the air chamber 16 to expand, and the pressure (negative pressure) of the expanded air moves the striker 17 rearward. In this way, the striker 17 is driven to reciprocate rearward and forward due to fluctuations (compression/expansion) in the air pressure in the air chamber 16 caused by the reciprocating motion of the piston 15, the striker 17 strikes the second hammer 18, and the second hammer 18 in turn strikes the tip tool 19.

In the rotational impact mode or the rotation mode, the cylinder 14 is rotationally driven by the intermediate shaft 8. The tool holding part 12 provided in front of the cylinder 14 rotates together with the cylinder 14. The tip tool 19 is held by the tool holding part 12 and extends forward from the body housing 4, and rotates together with the tool holding part 12. The rotation shaft of the tip tool 19 is coaxial with the rotation shaft of the cylinder 14 and will hereinafter be referred to as the “rotation shaft.” The tip tool 19 receives the driving force of the motor 6 and rotates around the rotation shaft.

The main board 20 is supported by the body housing 4 below the motor 6 in a position perpendicular to the up-down direction.

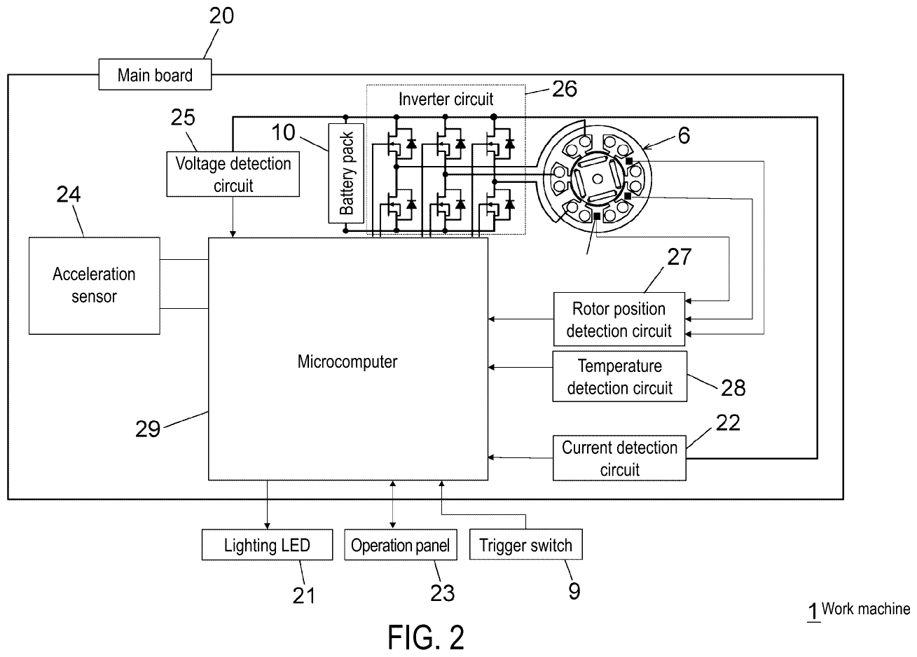

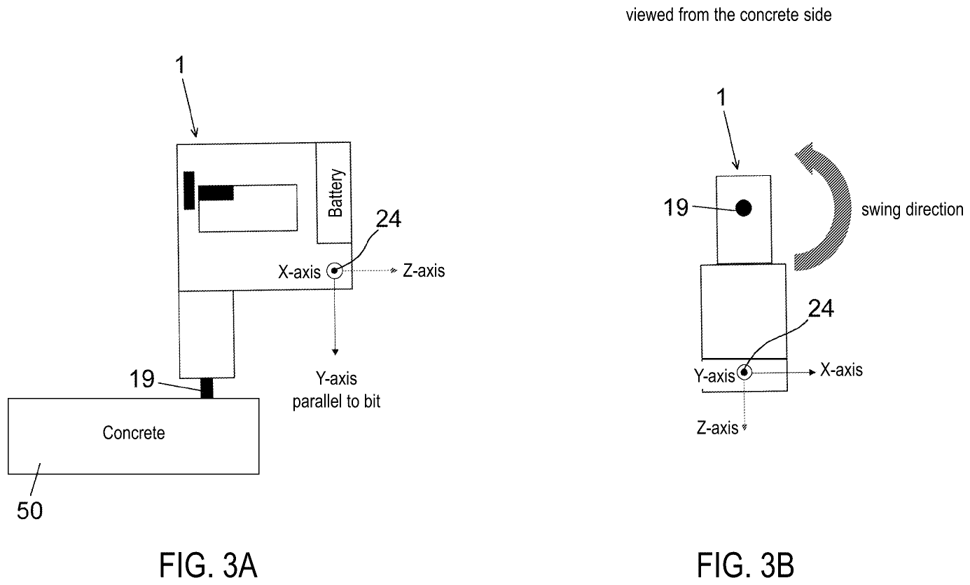

FIG. 2 is a circuit block diagram of the work machine 1. The work machine 1 includes, on the main board 20, a current detection circuit 22, an acceleration sensor 24 as a detection unit, a voltage detection circuit 25, an inverter circuit 26, a rotor position detection circuit 27, a temperature detection circuit 28, and a Microcomputer 29 (microcomputer or microcontroller) as a control unit. That is, the acceleration sensor 24 is provided in the body part 4a of the body housing 4. However, the acceleration sensor 24 may be provided in the handle part 4b.

The current detection circuit 22 detects the load current (hereinafter referred to as “load current”) flowing through the motor 6, and transmits it to the Microcomputer 29. The current detection circuit 22 and the acceleration sensor 24 form a detection unit. The acceleration sensor 24 is capable of detecting the acceleration occurring in itself. The voltage detection circuit 25 detects the output voltage of the battery pack 10 and transmits it to the Microcomputer 29. The inverter circuit 26 is a drive circuit that is made up of switching elements, such as FETs and IGBTs, connected in a three-phase bridge, and supplies a drive current to the motor 6.

The rotor position detection circuit 27 detects the rotor rotation position based on an output signal from a magnetic sensor 30 such as a Hall IC that outputs a signal corresponding to the rotation position (rotor rotation position) of the motor 6, and transmits it to a Microcomputer 29. The temperature detection circuit 28 detects the temperature of the inverter circuit 26 and transmits it to the Microcomputer 29.

The Microcomputer 29 controls the inverter circuit 26 in accordance with the mode set by the operation panel 23 and the operation of the trigger switch 9, for example, by PWM control, and controls the driving of the motor 6. The Microcomputer 29 controls the illumination of a lighting LED 21 that illuminates the work area and the panel LED provided on the operation panel 23.

(A) of FIG. 3 is a schematic diagram showing an example of a state of the work machine 1 during work. (B) of FIG. 3 is a schematic diagram of the work machine 1 in the state shown in (A) of FIG. 3 as viewed from the concrete side. The acceleration sensor 24 here is a three-axis acceleration sensor. The X, Y and Z axes shown in (A) and (B) of FIG. 3 are three orthogonal axes, and correspond to the detection axis of the acceleration sensor 24. The X-axis is parallel to the left-right direction, with the +X direction corresponding to the left direction and the-X direction corresponding to the right direction. The Y axis is parallel to the front-rear direction, with the +Y direction corresponding to the front direction and the −Y direction corresponding to the rear direction. The Z axis is parallel to the up-down direction, with the +Z direction corresponding to the down direction and the −Z direction corresponding to the up direction.

During work by the work machine 1, the tip tool 19 may get caught on a counter material, for example, concrete 50. At this time, the tip tool 19 is locked, and the work machine body (the entire work machine 1 excluding the tip tool 19) is swung around the locked tip tool 19 in the rotation direction shown in (B) of FIG. 3.

The work machine 1 has a function of reducing the rotation speed of the motor 6 or stopping the motor 6 when it detects that the work machine body is swinging (also referred to as a “swing control function” in this specification). When the swing control function is activated, stopping the motor 6 is preferable in terms of the effect of suppressing the swinging of the work machine body, but it is also possible to obtain a certain degree of suppression effect by reducing the rotation speed of the motor 6 without stopping the motor 6.

The Microcomputer 29 detects whether or not the work machine body is swinging based on the acceleration detection value of the acceleration sensor 24 in the Z-axis direction, i.e., the radial acceleration (centrifugal direction acceleration) occurring in the radial direction around the rotation shaft with respect to the acceleration sensor 24. The radial acceleration (centrifugal direction acceleration) is an acceleration that occurs along a virtual line (Z-axis) connecting the acceleration sensor 24 and the rotation shaft (or its extension) and in a direction away from the rotation shaft (+Z direction).

As an example of the configuration of the swing control function of this embodiment, the Microcomputer 29 reduces the rotation speed of the motor 6 or stops the motor 6 when the centrifugal direction acceleration exceeds a centrifugal direction acceleration threshold value as a first threshold value.

Alternatively, when the centrifugal direction acceleration exceeds a centrifugal direction acceleration threshold value as a first threshold value and the load current exceeds a current threshold value as a second threshold value, the Microcomputer 29 reduces the rotation speed of the motor 6 or stops the motor 6. The current threshold value is set such that the load current exceeds the current threshold value unless the tip tool 19 is in a no-load state where it is not in contact with the counter material.

Alternatively, when the centrifugal direction acceleration exceeds a centrifugal direction acceleration threshold value as a first threshold value and the acceleration detection value of the acceleration sensor 24 in the X-axis direction, i.e., the circumferential acceleration (left-right direction acceleration) occurring in the circumferential direction around the rotation shaft with respect to the acceleration sensor 24, exceeds a left-right direction acceleration threshold value as a third threshold value, the Microcomputer 29 reduces the rotation speed of the motor 6 or stops the motor 6. The left-right direction acceleration threshold value is a threshold value for confirming that left-direction acceleration with respect to the acceleration sensor 24, i.e. the acceleration in the direction in which the work machine body swings due to the reaction when the motor 6 attempts to rotate the rocked tip tool 19 is occurring.

Moreover, “exceeding the threshold value” specifically means “maintaining a state in which the threshold value is exceeded for a predetermined period of time.” For example, even if the centrifugal direction acceleration momentarily exceeds the first threshold value, if it falls below the first threshold value again within a predetermined period of time, it is judged that the first threshold value has not been exceeded. This makes it possible to ignore, as noise, the phenomenon in which the numerical value momentarily exceeds the threshold value due to vibration or the like even though no swinging is actually occurring. Of course, it is also possible to judge that the value has “exceeded the threshold value” if the numerical value exceeds the threshold value even for a very short period of time, without taking time into consideration.

The Microcomputer 29 sets the centrifugal direction acceleration threshold value, the current threshold value, and the left-right direction acceleration threshold value to different values in the high-speed mode and the low-speed mode (sets to be higher in the high-speed mode). For example, in the high-speed mode, the Microcomputer 29 sets the current threshold value to 8.0 A, the left-right direction acceleration threshold value to 1.0 G, and the centrifugal direction acceleration threshold value to 2.0 G, and in the low-speed mode, sets the current threshold value to 4.0 A, the left-right direction acceleration threshold value to 0.5 G, and the centrifugal direction acceleration threshold value to 0.75 G.

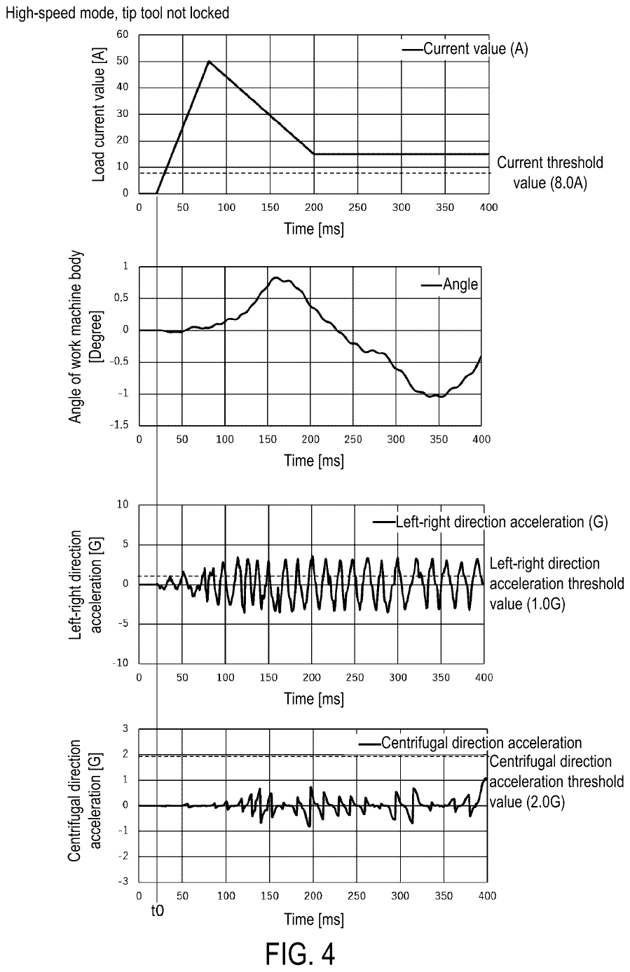

FIG. 4 is a time chart of the load current, the angle of the work machine body, the acceleration detection value by the acceleration sensor 24 in the X-axis direction (left-right direction acceleration), and the acceleration detection value by the acceleration sensor 24 in the Z-axis direction (centrifugal direction acceleration) when the work machine 1 is in high-speed mode and during normal cutting, i.e., when the tip tool 19 is not locked. Moreover, all of the time charts in FIG. 4 to FIG. 7 show the case where the tip tool 19 rotates clockwise, and when the tip tool 19 rotates counterclockwise, the positive and negative of the left-right direction acceleration threshold value are reversed.

In FIG. 4, at time to, the trigger switch 9 is turned on. The load current increases temporarily during the period from when the trigger switch 9 is turned on (near 20 ms) until 200 ms, that is, when the motor 6 is started, but thereafter settles down to about 10 A. The angle of the work machine body is generally constant, although there is a touch of about ±1° due to vibrations during work, or the like. The left-right direction acceleration fluctuates within a range of about ±3 G (G is the acceleration due to gravity) due to vibrations during work, but is approximately zero on average. The centrifugal direction acceleration fluctuates within a range of about ±1 G due to vibrations during work, etc., but does not exceed the centrifugal direction acceleration threshold value (2.0 G) and is approximately zero on average.

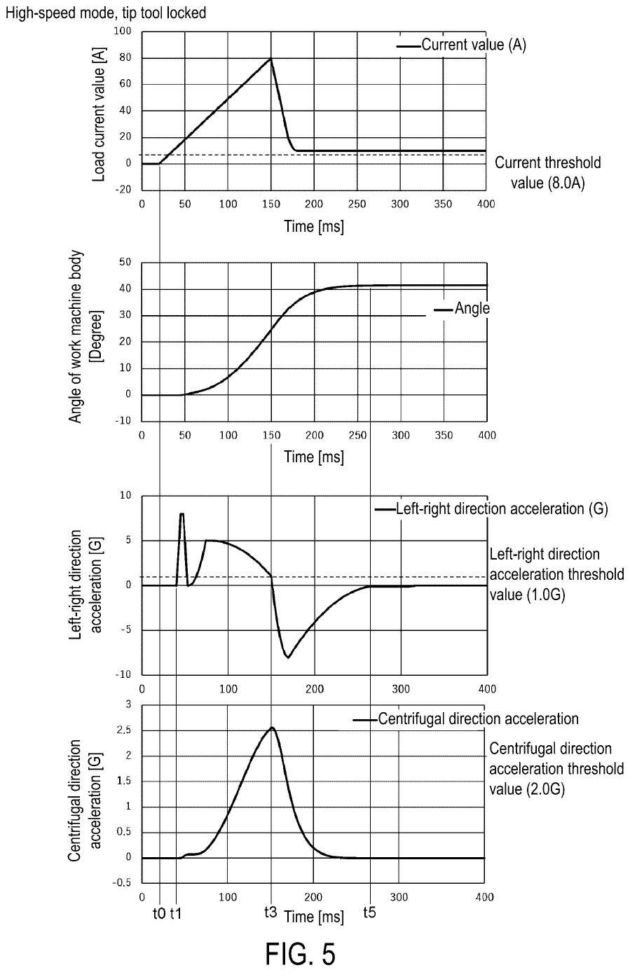

FIG. 5 is a time chart of the load current, the angle of the work machine body, the acceleration detection value by the acceleration sensor 24 in the X-axis direction (left-right direction acceleration), and the acceleration detection value by the acceleration sensor 24 in the Z-axis direction (centrifugal direction acceleration) when the work machine 1 is in high-speed mode, the tip tool 19 is locked midway, and the swing control function is not activated.

In FIG. 5, the trigger switch 9 is turned on at time to, the tip tool 19 is fixed to the counter material at time t1 (near 40 ms), the worker begins to press the work machine body at time t3 (near 150 ms), and the vibration of the work machine body stops at time t5 (near 270 ms) just after exceeding 40°.

The left-right direction acceleration momentarily jumps up to about 8 G immediately after time t1, drops to near 0, then rises to about 5 G and then drops again, reaching 0 at time t3. After time t3, the left-right direction acceleration becomes negative due to the force of the worker trying to stop the work machine body, and becomes 0 at time t5.

The centrifugal direction acceleration begins to rise from time t1 and reaches a peak value just above 2.5 G (a peak value exceeding the centrifugal direction acceleration threshold value) immediately before the worker begins to press the work machine body at time t5, that is, at the timing when the swing angular velocity of the work machine body around the tip tool 19 reaches its maximum. After time t3, the centrifugal direction acceleration decreases in accordance with the deceleration of the swinging speed of the work machine body caused by the worker, and becomes 0 at time t5.

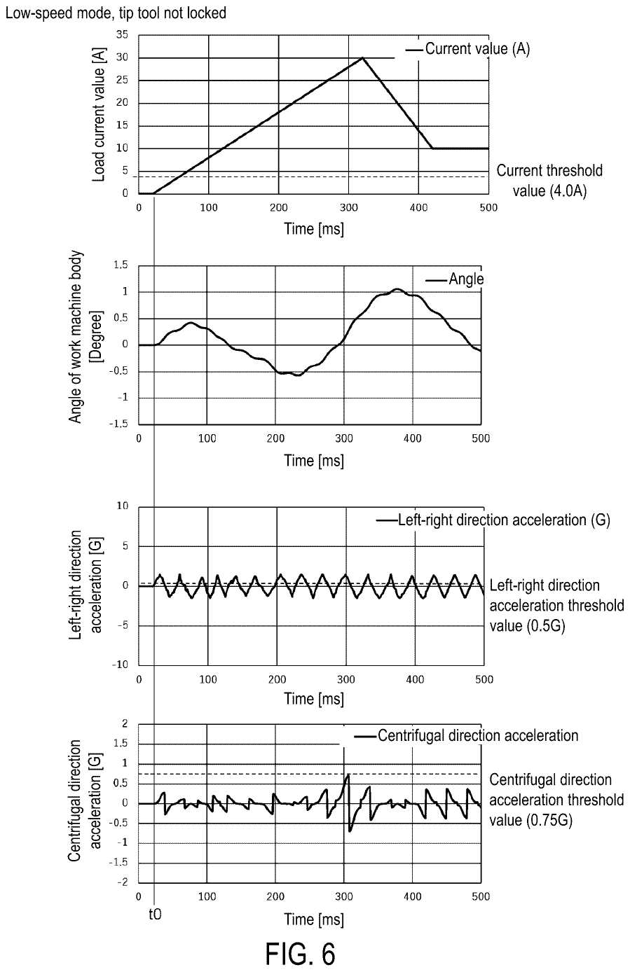

FIG. 6 is a time chart of the load current, the angle of the work machine body, the acceleration detection value by the acceleration sensor 24 in the X-axis direction (left-right direction acceleration), and the acceleration detection value by the acceleration sensor 24 in the Z-axis direction (centrifugal direction acceleration) when the work machine 1 is in low-speed mode and during normal cutting, i.e., when the tip tool 19 is not locked.

In FIG. 6, the trigger switch 9 is turned on at time to. The load current increases temporarily during the period from when the trigger switch 9 is turned on (near 20 ms) until 320 ms, that is, when the motor 6 is started, but thereafter settles down to a constant value. The angle of the work machine body is generally constant, although there is a touch of about ±1° due to vibrations during work, etc. The left-right direction acceleration fluctuates within a range of about ±1.5 G due to vibrations during work, etc., but is approximately zero on average. The centrifugal direction acceleration fluctuates within a range of about ±0.7 G due to vibrations during work, etc., but does not exceed the centrifugal direction acceleration threshold value (0.75 G) and is approximately zero on average.

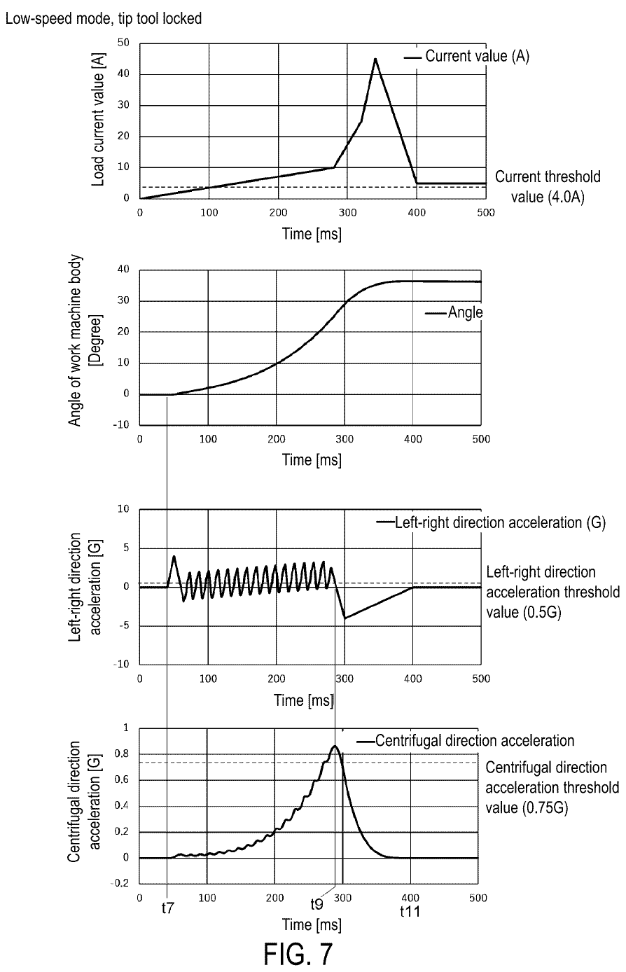

FIG. 7 is a time chart of the load current, the angle of the work machine body, the acceleration detection value by the acceleration sensor 24 in the X-axis direction (left-right direction acceleration), and the acceleration detection value by the acceleration sensor 24 in the Z-axis direction (centrifugal direction acceleration) when the work machine 1 is in low-speed mode, the tip tool 19 is locked midway, and the swing control function is not activated.

In FIG. 7, the trigger switch 9 is turned on at 0 ms, the tip tool 19 is fixed to the counter material at time t7 (near 40 ms), the worker begins to press the work machine body at time t9 (near 280 ms), and the swinging of the work machine body stops at time t11 (near 400 ms) just after exceeding 35°.

The left-right direction acceleration jumps up to about 4 G momentarily immediately after time t7, then drops to near 0, and thereafter vibrates while gradually increasing from 0 as an average value, returning to 0 at time t9. After time t9, the left-right direction acceleration becomes negative due to the worker trying to stop the work machine body, and becomes 0 at time t11.

The centrifugal direction acceleration begins to rise from time t7 and reaches a peak value just above 0.8 G (a peak value exceeding the centrifugal direction acceleration threshold value) immediately before the worker begins to press the work machine body at time t9, that is, at the timing when the swing angular velocity of the work machine body around the tip tool 19 reaches its maximum. After time t9, the centrifugal direction acceleration decreases in accordance with the deceleration of the swinging speed of the work machine body caused by the worker, and becomes 0 at time t11.

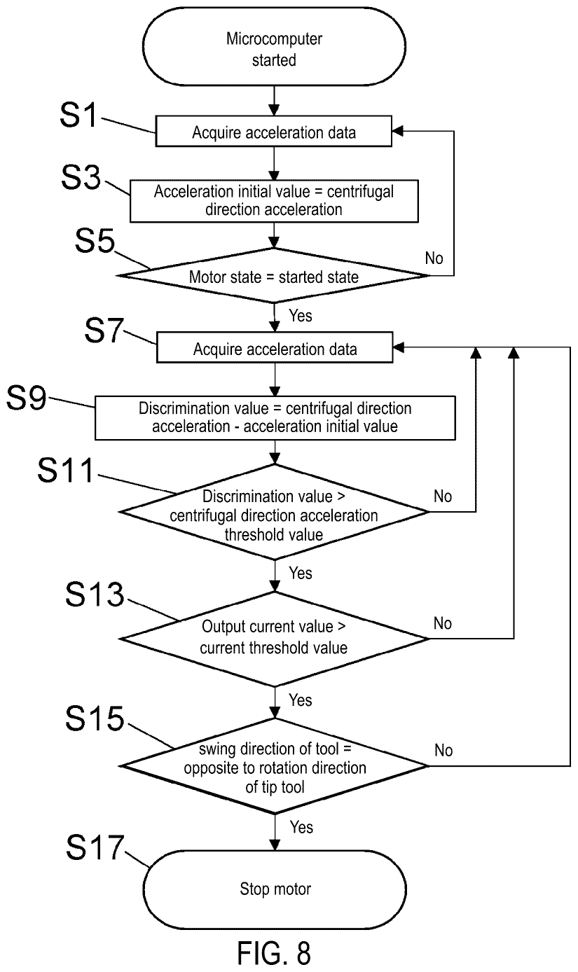

FIG. 8 is a control flowchart of the work machine 1. The Microcomputer 29 acquires acceleration data, that is, the acceleration detection value by the acceleration sensor 24 (S1). The Microcomputer 29 substitutes the acceleration detection value in the Z-axis direction (centrifugal direction acceleration) included in the acceleration data into an acceleration initial value (S3). When the motor 6 is not in a started state (No in S5), the Microcomputer 29 returns to S1. The centrifugal direction acceleration immediately after the motor 6 is started is set in the acceleration initial value. Moreover, the acceleration initial value may also be zero.

When the motor 6 is in a started state (Yes in S5), the Microcomputer 29 acquires acceleration data (S7). The Microcomputer 29 substitutes a value obtained by subtracting the acceleration initial value set in S3 from the centrifugal direction acceleration included in the acceleration data into a discrimination value.

When the discrimination value does not exceed the centrifugal direction acceleration threshold value (No in S11), the Microcomputer 29 returns to S7. When the discrimination value exceeds the centrifugal direction acceleration threshold value (Yes in S11), the Microcomputer 29 confirms whether or not the load current exceeds the current threshold value (S13).

When the load current does not exceed the current threshold value (No in S13), the Microcomputer 29 returns to S7. This makes it possible to suppress the activation of the swing control function when the worker moves the work machine body while the motor 6 is rotating in a no-load state.

When the load current exceeds the current threshold value (Yes in S13), the Microcomputer 29 calculates the swing direction of the work machine body from the acceleration detection value in the X-axis direction (left-right direction acceleration) included in the acceleration data, and confirms whether or not the swing direction is opposite to the rotation direction of the tip tool (S15). More specifically, when the motor 6 rotates in a direction in which the tip tool 19 rotates counterclockwise in a rear view, it is confirmed whether or not the acceleration in the clockwise direction (i.e., left-direction acceleration) exceeds a threshold value. Furthermore, when the motor 6 rotates in a direction in which the tip tool 19 rotates clockwise in a rear view, it is confirmed whether or not the acceleration in the counterclockwise direction (i.e., right-direction acceleration) exceeds a threshold value.

The Microcomputer 29 calculates the swing direction of the work machine body, and returns to S7 when the swing direction is not opposite to the rotation direction of the tip tool (No in S15). This makes it possible to prevent the swing control function from being erroneously activated, for example, when the worker swings the work machine body in a direction different from the direction in which acceleration is estimated to occur when the tip tool 19 is locked.

When the swing direction of the work machine body is opposite to the rotation direction of the tip tool (Yes in S15), the Microcomputer 29 reduces the rotation speed of the motor 6 or stops the motor 6 (S17).

According to this embodiment, it is possible to obtain the following effects.
(1) The Microcomputer 29 controls the driving of the motor 6 based on the radial acceleration (centrifugal direction acceleration) that occurs in the radial direction around the rotation shaft with respect to the acceleration sensor 24. Specifically, when the centrifugal direction acceleration exceeds a centrifugal direction acceleration threshold value, the Microcomputer 29 reduces the rotation speed of the motor 6 or stops the motor 6. This makes it possible to properly detect the state in which the work machine body is swinging, and the swing control function can be appropriately activated.

Here, for comparison, a case will be considered in which whether or not the work machine body is swinging is judged based on whether or not the left-right direction acceleration has exceeded a threshold value. The left-right direction acceleration momentarily shows a large value when the tip tool 19 is locked, but then decreases. For this reason, it is difficult to distinguish a momentary large value of the left-right direction acceleration caused by the locking of the tip tool 19 from that caused by noise or momentary vibration. Furthermore, if one tries to make a judgment after a momentary large value has passed, the left-right direction acceleration decreases over time, so as time passes it becomes more difficult to distinguish whether the work machine body is not swinging or whether the swinging speed has become almost constant. When deriving the swing speed of the work machine body from the left-right direction acceleration, an integral calculation of the left-right direction acceleration is necessary, but the error contained in the detection value of the left-right direction acceleration itself is also integrated, resulting in a large error.

In this regard, the centrifugal direction acceleration becomes a large value, not momentarily, when the tip tool 19 is locked. For this reason, a large value of the centrifugal direction acceleration due to the locking of the tip tool 19 can be easily distinguished from a momentary large value due to noise or momentary vibration. Furthermore, since the rotational speed at which the work machine body swings increases over time, it does not become difficult to distinguish whether the work machine body is not swung or the swung speed has become approximately constant over time. Further, the centrifugal direction acceleration is proportional to the square of the rotational speed at which the work machine body swings, and corresponds directly to the rotational speed at which the work machine body swings. Thus, the rotational speed at which the work machine body swings may be estimated from the centrifugal direction acceleration without using integral calculations, and the error is small. In this embodiment, by judging whether or not the work machine body is swinging based on the centrifugal direction acceleration, it is possible to appropriately detect the state in which the work machine body is swinging.
(2) The Microcomputer 29 makes the load current exceeding the current threshold value (not being in a no-load state) a necessary condition for activating the swing control function. Thus, it is possible to suppress the activation of the swing control function when the worker moves the work machine body while the motor 6 is rotating in a no-load state.
(3) The Microcomputer 29 makes the swing direction of the work machine body being opposite to the rotation direction of the tip tool a necessary condition for activating the swing control function. Thus, for example, when the worker swings the work machine body in a direction different from the direction in which acceleration is estimated to occur when the tip tool 19 is locked, it is possible to prevent the swing control function from being erroneously activated.

Although the present invention has been described above by taking the embodiment as an example, various modifications may be made to each component and each processing step of the embodiment within the scope of the claims. The following describes modified examples.

The work machine of the present invention is not limited to a hammer drill, but may be of other types such as a driver drill or a drill. The load current value, acceleration, time, various threshold values, and the like given as specific numerical values in the embodiments do not limit the scope of the invention in any way and may be changed arbitrarily according to the required specifications.

### REFERENCE SIGNS LIST

1 . . . Work machine (hammer drill)
2. Body
3 . . . Dust collection unit
4 . . . Body housing
6 . . . Motor (electric motor)
6a . . . Output shaft
7 . . . Deceleration mechanism
8 . . . Intermediate shaft
9 . . . Trigger switch
10 . . . Battery pack
11a . . . First clutch mechanism
11b . . . Second clutch mechanism
12 . . . Tool holding part
13 . . . Reciprocating bearing
14 . . . Cylinder
15 . . . Piston
16 . . . Air chamber
17 . . . Striker (impacting part)
18 . . . Second hammer (intermediate part)
19 . . . Tip tool
20 . . . Main board
21 . . . Lighting LED
22 . . . Current detection circuit
23 . . . Operation panel
24 . . . Acceleration sensor
25 . . . Voltage detection circuit
26 . . . Inverter circuit
27 . . . Rotor position detection circuit
28 . . . Temperature detection circuit
29 . . . Microcomputer (control unit)
30 . . . Magnetic sensor
50 . . . Concrete (counter material)

1. A work machine, comprising:
a motor;
a tip tool that rotates around a rotation shaft by receiving a driving force from the motor;
a housing that supports the motor and the tip tool;
a control unit that controls driving of the motor;
a detection unit supported by the housing and capable of detecting an acceleration occurring in itself;
wherein the control unit controls the driving of the motor based on a radial acceleration occurring in a radial direction around the rotation shaft with respect to the detection unit.

2. The work machine according to claim 1, wherein the control unit reduces a rotation speed of the motor when the radial acceleration exceeds a first threshold value.

3. The work machine according to claim 1, wherein the control unit stops the motor when the radial acceleration exceeds a first threshold value.

4. The work machine according to claim 1, wherein
the detection unit is also capable of detecting a load current of the motor, and
the control unit reduces a rotation speed of the motor when the radial acceleration exceeds a first threshold value and the load current exceeds a second threshold value.

5. The work machine according to claim 1, wherein the control unit reduces a rotation speed of the motor when the radial acceleration exceeds a first threshold value and when a circumferential acceleration occurring in a circumferential direction around the rotation shaft with respect to the detection unit exceeds a third threshold value.

6. The work machine according to claim 1, wherein the radial acceleration is an acceleration occurring in a direction along a virtual line connecting the detection unit and the rotation shaft and in a direction away from the rotation shaft.

7. The work machine according to claim 2, wherein the radial acceleration is an acceleration occurring in a direction along a virtual line connecting the detection unit and the rotation shaft and in a direction away from the rotation shaft.

8. The work machine according to claim 3, wherein the radial acceleration is an acceleration occurring in a direction along a virtual line connecting the detection unit and the rotation shaft and in a direction away from the rotation shaft.

9. The work machine according to claim 4, wherein the radial acceleration is an acceleration occurring in a direction along a virtual line connecting the detection unit and the rotation shaft and in a direction away from the rotation shaft.

10. The work machine according to claim 5, wherein the radial acceleration is an acceleration occurring in a direction along a virtual line connecting the detection unit and the rotation shaft and in a direction away from the rotation shaft.

11. The work machine according to claim 1, wherein the radial acceleration is an acceleration occurring when the housing is swung in a rotation direction around the rotation shaft.

12. A work machine, comprising:
a motor;
a tip tool that rotates around a rotation shaft by receiving a driving force from the motor;
a housing that supports the motor and the tip tool;
a control unit that controls driving of the motor;
a detection unit supported by the housing and capable of detecting an acceleration occurring in itself;
wherein when the tip tool gets caught on a counter material and the housing is swung, the control unit controls the driving of the motor based on an acceleration occurring in a direction intersecting a direction in which the housing is swung with respect to the detection unit.

13. The work machine according to claim 12, wherein when the housing is swung in a rotation direction around the rotation shaft, the control unit controls the driving of the motor based on the acceleration occurring in the direction intersecting the rotation direction with respect to the detection unit.

14. The work machine according to claim 13, wherein the control unit controls the driving of the motor based on a radial acceleration occurring in a radial direction around the rotation shaft with respect to the detection unit.

15. A work machine, comprising:
a motor;
a tip tool that rotates around a rotation shaft by receiving a driving force from the motor;
a housing that supports the motor and the tip tool;
a control unit that controls driving of the motor;
a detection unit supported by the housing and capable of detecting an acceleration occurring in itself;
wherein when the housing is swung in a rotation direction around the rotation shaft, controls the driving of the motor based on a centrifugal direction acceleration occurring in a radial direction around the rotation shaft with respect to the detection unit.
